(19) United States
(12) Patent Application Publication
(10) Pub. No.: US 2009/0111445 A1
(43) Pub. Date: Apr. 30, 2009

(54) METHOD AND APPARATUS FOR CONTROLLING UPLINK TRANSMISSION TIMING IN A COMMUNICATION NETWORK

(75) Inventors: Rapeepat Ratasuk, Hoffman Estates, IL (US); Igor Filipovich, Chicago, IL (US); Amitava Ghosh, Buffalo Grove, IL (US); Weimin Xiao, Hoffman Estates, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/926,859

(22) Filed: Oct. 29, 2007

(51) Int. Cl. H04M 3/00

(52) U.S. Cl. 455/418

(57) ABSTRACT

A method and corresponding system for controlling uplink timing in a communication network (100) is described. The method comprises of scheduling a mobile device (104) to transmit a preamble over a physical random access channel. The mobile device (104) is scheduled to transmit the preamble over a physical random access channel at a selected random access slot. The method then includes receiving the preamble transmitted by the scheduled mobile device (104). The preamble is received over the physical random access channel. The method further comprises measuring a timing offset at which the preamble is received from the scheduled mobile device (104) and determining a timing adjustment value in uplink transmission timing based on the measured timing offset. The method then comprises transmitting a timing advance command comprising the determined timing adjustment value in a control message to the mobile device (104) for controlling uplink transmission timing at the mobile device (104).

### FIELD OF THE INVENTION

The present invention generally relates to a communication network and more particularly relates to controlling uplink transmission timing in the communication network.

### BACKGROUND

In a wireless communication system, typically communication is established between a node and a plurality of mobile devices. The mobile device establishes a link, known as uplink, for communicating data to the node. Since there is plurality of mobile devices in the communication system, the data is communicated within a pre-defined time interval assigned to each of the mobile devices. Typically, transmission of data over the uplink at a specified time is known as uplink transmission, and such transmission timing is known as uplink transmission timing. For effective transmission, the uplink transmission timing is maintained within the pre-defined time interval assigned to the mobile device such that uplink transmissions from all mobile devices are time aligned within a receiver window of the node. However, in some circumstances, there may be misalignment in uplink transmission timing and may interpose with adjacent time interval. Because of such misalignment, there will be interference with other mobile devices and with other data transmitted in an adjacent time interval. Thus, it is very important to control the uplink transmission timing of each of the mobile devices in the communication system.

In the existing technique, the mobile device transmits a control sounding reference e.g. channel quality indicator (CQI), or data signal as an uplink transmission signal to the node. The node, in return, measures the uplink transmission timing of the received signal and transmits a timing advance message to the mobile device. However in this technique, due to some circumstances, the signal may not be transmitted or transmitted less frequently than the required timing update period. Transmitting the signal more frequently than necessary for the purpose of uplink transmission timing measurement will result in an unnecessary increase in the overhead. In addition, the timing advance message transmitted by the node is a higher layer message, which is specifically used for updating uplink transmission timing of the mobile device. Since the timing advance message is a higher layer message, the message requires high over head and also creates high decoding complexity at the mobile device.

Thus, there is a need to send the uplink transmission signal for uplink transmission timing measurement without incurring unnecessary overhead and also there is a need to receive a timing advance message with minimal overhead and complexity.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a system diagram of a communication network in accordance with some embodiments of the invention;

FIG. 2 is a block diagram of a system comprising a node in accordance with some embodiments of the invention;

FIG. 3 is a block diagram of a system comprising a mobile device in accordance with some embodiments of the invention;

FIG. 4 is a flowchart of a method for determining a timing adjustment value in uplink transmission timing in accordance with some embodiments of the invention;

FIG. 5 is a flowchart of a method for controlling uplink transmission timing in the communication network in accordance with some embodiments of the invention; and

FIG. 6 is a flow chart of a method for determining the presence of a timing advance command in a control message in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing any details, it should be observed that the embodiments reside primarily in an apparatus and method for controlling uplink transmission timing in a communication network. Accordingly, the apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of this description.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that the embodiments described herein may be comprised of one or more conventional processors and unique stored program instructions that control the one or more processors to implement, in conjunction with certain non-processor circuits, some, most, or all of the functions required for controlling uplink transmission timing in the communication network are described herein. The non-processor circuits may include, but are not limited to, a radio receiver, a radio transmitter, signal drivers, clock circuits, power source circuits, and user input devices. As such, these functions may be interpreted as steps of a method for controlling uplink transmission timing in the communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments are disclosed herein. For example, one method includes allocating a preamble or signature and scheduling a mobile device to transmit a preamble or signature over a physical random access channel (PRACH). The preamble is associated with an uplink signal at the mobile device. The method includes receiving the preamble transmitted by the scheduled mobile device and measuring a timing offset at which the preamble is received from the scheduled mobile device. The method further includes determining a timing adjustment value in uplink transmission timing based on the measured timing offset, and transmitting a timing advance command comprising the determined timing adjustment value in a control message to the mobile device for controlling uplink transmission timing at the mobile device. The mobile device then advance or retard its uplink transmission timing based on the timing adjustment value contained in the timing advance command. Timing advance command transmitted in a control message will allow the mobile device with the maximum timing offset (corresponding to the maximum supported cell radius) to synchronize or control the uplink transmission timing in the communication network.

Another embodiment includes a system comprising a node for controlling uplink transmission timing in the communication network. The node includes an assigning module to allocate a preamble to the mobile device, and a scheduling module to schedule the mobile device to transmit the allocated preamble over a physical random access channel. The node further includes a processor communicatively coupled between the assigning module and the scheduling module that is operable to measure a timing offset at which the preamble is received from the scheduled mobile device. The processor is further operable to determine a timing adjustment value in uplink transmission timing based on the measured timing offset. The system further comprises a transceiver for transmitting the determined timing adjustment value to the mobile device for controlling uplink transmission timing at the mobile device.

In yet another embodiment, a method includes receiving a preamble allocated by a node, wherein the preamble is associated with an uplink signal, and transmitting the preamble over a physical random access channel at a selected random access time and frequency slot. The method further includes receiving a timing advance command in a control message in response to the transmitted preamble and controlling the uplink transmission timing based on the received timing advance command.

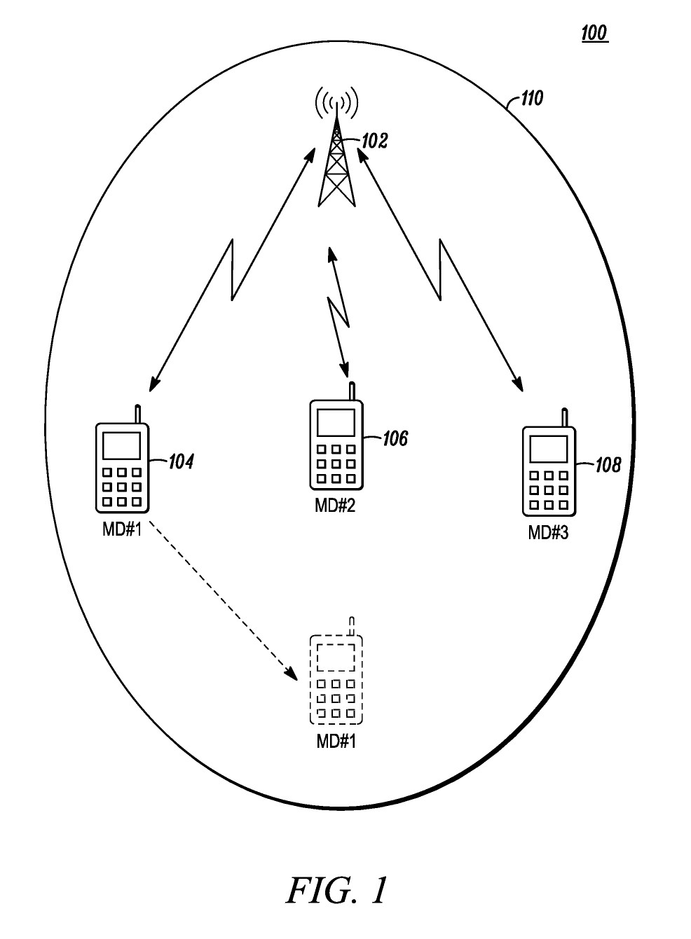

FIG. 1 illustrates a system diagram of a communication network 100 that the embodiments described utilize. The communication network 100 includes a node 102 and a plurality of mobile devices 104, 106 and 108. The mobile devices 104-108 are located at different positions in the communication network 100. Each of the mobile devices 104-108 establishes a link for communicating data to the node 102. The mobile devices 104-108 may communicate with each other or with other mobile devices through the node 102. In one embodiment, the mobile devices 104-108 may directly communicate with each other using short range technology. Examples of short range RF technology include Bluetooth, Wi-Fi, Zigbee and similar protocols.

In one embodiment, the mobile device 104 establishes a link to communicate data to the node 102. Such a link is known as uplink, and the communication established over such a link is known as uplink communication. The embodiment is described from the perspective of mobile device 104. The embodiment described herein is applicable to any mobile device in the communication network 100 and not limited to the mobile device 104. The mobile device 104 transmits data to the node 102 within a pre-defined time interval. The pre-defined time interval is the time duration allocated to each of the mobile devices 104-108 for communicating data to the node 102. The mobile device 104 transmits data at a specified time to the node 102. The time at which the node 102 receives data from the mobile device 104 is known as uplink transmission timing. Typically, the uplink transmission timing is maintained within the pre-defined time interval such that uplink transmissions from all mobile devices are time aligned within a receiver window of the node. However, in some instance, the uplink transmission timing may exceed the allocated time interval, and may interpose with an adjacent time interval. Thus, the mobile device 104 has to control/synchronize the uplink transmission timing to prevent interference with other mobile devices and with other data in the adjacent time interval.

In one embodiment, the uplink transmission timing is controlled or synchronized by transmitting a preamble as a time measurement uplink signal from the mobile device 104 to the node 102. The preamble is a low overhead signal that is transmitted over a physical random access channel. The preamble may be a dedicated preamble or a random preamble. The preamble that is selected randomly by the mobile device 104 for timing estimation is known as random preamble. Similarly, the preamble that is reserved and allocated by the node 102 specifically for timing estimation is known as dedicated preamble. The preamble may be known as a signature or any other similar terminology that is used in 3GPP or other standards.

The node measures a timing offset at which the transmitted preamble is received from the mobile device 104. The timing offset is the offset in the current transmission timing from a pre-defined uplink transmission timing of the mobile device 104. The node 102 further determines a timing adjustment value in uplink transmission timing based on the measured timing offset. The node 102 then transmits a timing advance command comprising the timing adjustment value back to the mobile device 104 in a control message for controlling the uplink transmission timing at the mobile device 104. The timing advance command may be a data, information, or a message that may be encapsulated in the low over head control message.

In an embodiment, each of the mobile devices 104-108 in the communication network 100 may be a wireless device, a mobile station, a user equipment, or any similar device that can transmit and receive signals. In an embodiment, each of the mobile devices 104-108 are configured to operate according to any of a number of different 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Single Carrier Frequency Division Multiple Access (SC-FDMA), Discrete Fourier Transform-Spread Orthogonal Frequency Division Multiplexing (DFT-SOFDM), Interleaved Frequency-Division Multiple Access (IFDMA), Worldwide Interoperability for Microwave Access (WiMax), Long-Term Evolution (LTE) and other communication technologies. The mobile devices 104-108 may also communicate with each other or with any other mobile devices using an IEEE 802.16-based wireless metropolitan area network or other technologies.

In an embodiment, the node 102 establishes communication with each of the mobile devices 104-108. The node 102 transmits and receives signals from different mobile devices and infrastructure components (not shown) of the node 102 that provide wireless communication to each of the mobile devices 104-108. The node 102 may include a switching center that establishes a communication session between the mobile devices 104-108 or with the mobile devices in another network. The node may be a base station, an access point, an evolved node B (eNB) or any similar device that can control uplink transmission timing in the communication network 100.

An actual network may be significantly more complex and may include various additional known entities, such as base site controllers, billing, authorization, authentication, and voice mail servers that are not directly relevant to the present discussion. It is possible that neighboring networks may operate using the same or different communication technologies. The embodiments described focus on establishing communication between mobile devices 104-108.

Operationally, the node 102 allocates a preamble to the mobile device 104, the preamble being associated with an uplink transmission signal at the mobile device 104. The allocated preamble is as dedicated preamble. In one embodiment, the node 102 reserves a set of preambles in each physical random access channel for performing a dedicated function in the communication network 100. The dedicated function may be measuring uplink transmission timing of each of the mobile devices 104-108 in the communication network 100. For example, in a long term evolution (LTE) network, there are 64 preambles in each physical random access channel and the node 102 may reserve 4 preambles in each physical random access channel for performing uplink transmission timing measurement in the communication network 100. The node 102 allocates the dedicated preamble from the set of reserved preambles in the physical random access channel.

The node 102 allocates such dedicated preamble to the mobile device 104 for measuring uplink transmission timing of the mobile device 104. Further, the node 102 schedules the mobile device 104 to transmit the allocated preamble as an uplink transmission signal.

At the other end, the mobile device 104 associates the allocated preamble with the uplink transmission signal and transmits the allocated preamble when the mobile device 104 is scheduled by the node 102. The allocated preamble is transmitted over a physical random access channel at a selected random access time and frequency slot to the node 102.

On the other hand, the node 102 receives the transmitted preamble from the mobile device 104 and measures a timing offset at which the preamble is received from the mobile device 104. Further, the node 102 determines a timing adjustment value in uplink transmission timing based on the measured timing offset. The node 102 then transmits a timing advance command including the determined timing adjustment value in a control message for controlling the uplink transmission timing at the mobile device 104. The control message is a physical layer message and hence transmitted with low overhead to the mobile device 104. In one embodiment, the control message is an uplink/downlink scheduling grant message.

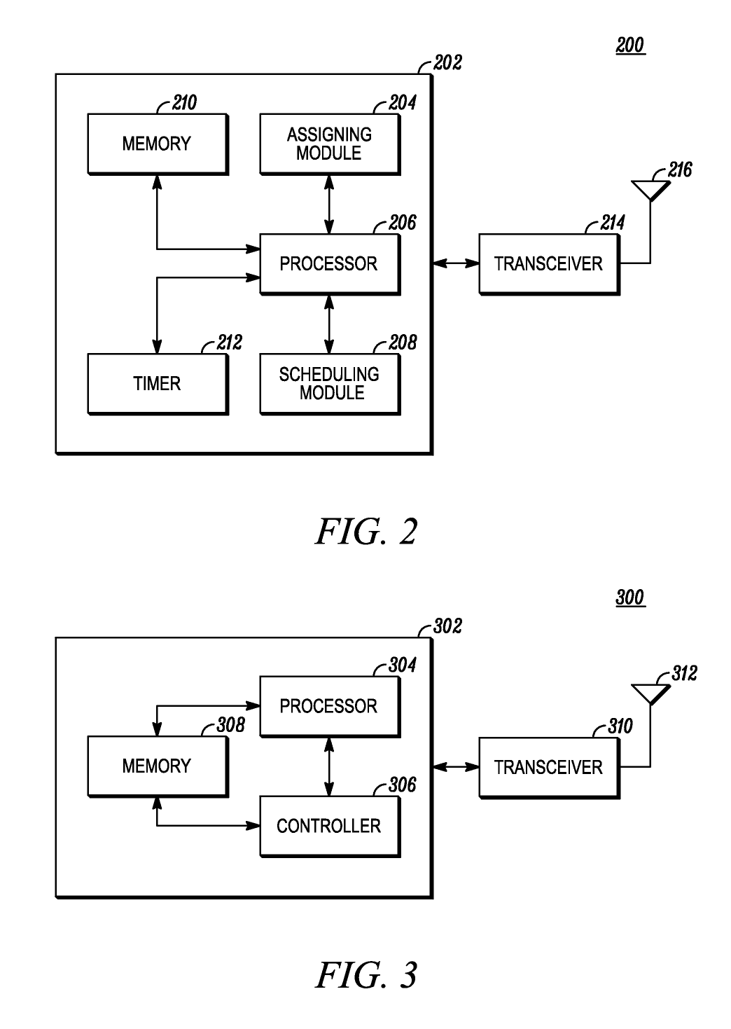

FIG. 2 is a block diagram of a system comprising a node in accordance with some embodiments of the invention. The system 200 comprises the node 202, a transceiver 214, and an antenna 216. The system 200 may be suitable for use as a node 102 of the communication network 100 shown in FIG. 1.

The node 202 may be a base station controller that establishes communication with the mobile devices 104-108 in the communication network 100. The node 202 includes a processor 206, an assigning module 204, a scheduling module 208, a memory 210 and a timer 212 for controlling uplink transmission timing in the communication network 100.

The memory 210 is a common storage unit that stores information related to a cell layout, a past update interval, a past timing advance command, a timer expiration and mobility information of the mobile device 104 in the communication network 100. The cell layout defines a geographical boundary 110 within which the mobile device 104 is communicatively coupled to the node 102. The past update interval is a time duration that has taken place after the last uplink transmission timing update. The timer expiration is expiry of a time period within which the uplink transmission signal is expected from the node in a periodic transmission. The past timing advance command is the information on time duration that has taken place after the last transmission of the timing advance command. The mobility information of the mobile device 104 relates to a speed at which the mobile device 104 travels and a position of the mobile device 104 in the communication network 100.

The processor 206 coupled to the memory 210 operates to determine a timing adjustment value in uplink transmission timing of the mobile device 104. The processor 206 receives a preamble associated within an uplink signal from the mobile device 104 and measures a timing offset at which the preamble is received from the mobile device 104. The measured timing offset is then used for determining a timing adjustment value in uplink timing of the mobile device 104. Further, the processor 206 transmits the determined timing adjustment value in a control message to the mobile device 104 for controlling uplink transmission timing at the mobile device 104.

The assigning module 204 is coupled to the processor 206 for allocating a preamble to the mobile device 104. In one embodiment, the assigning module 204 reserves a set of preambles in each physical random access channel to allocate such reserved preambles as the dedicated preambles to the mobile devices 104-108 for measuring the uplink transmission timing of the mobile devices 104-108 in the communication network 100. The assigning module 204 allocates the preamble by broadcasting the preamble to a plurality of mobile devices 104-108 in the communication network 100. The mobile device 104 to which the preamble is allocated will associate the preamble with an uplink signal. The other mobile devices 106 and 108 to which the preamble is not allocated will refrain from selecting the preamble as the uplink transmission signal.

The scheduling module 208 is coupled to the processor 206 for scheduling the mobile device 104 to transmit the preamble over a physical random access channel. In one embodiment, the scheduling module 208 schedules the mobile device 104 to transmit the allocated preamble periodically to the node 202. The mobile device 104 is allocated with a time and frequency slot to transmit the preamble periodically. In another embodiment, the scheduling module 208 schedules the mobile device 104 based on the information such as the past update interval, past timing advance command, the cell layout, timer expiration or the mobility of the mobile device 104, stored in the memory 210. For example, the mobile device 104 may analyze the past update interval of the mobile device 104 stored in the memory 210. If the past update interval is above pre-defined threshold interval, the mobile device 104 is scheduled for transmitting the preamble to the node 202. Similarly, the scheduling module 208 uses other information such as the cell layout or the mobility of the mobile device, stored in the memory 210 for scheduling the mobile device 104 to transmit the preamble to the node 202.

The timer 212 is coupled to the processor 206 for monitoring the time period at which the preamble is received from the mobile device 104. The processor 206 utilizes the timer 212 for measuring the timing offset at which the preamble is received from the mobile device 104. In one embodiment, the timer 212 may be embedded within the processor 206 for measuring the timing offset.

Operationally, the node 102 utilizes assigning module 204 for allocating a preamble to the mobile device 104 in the communication network 100. The node 102 further utilizes the scheduling module 208 to schedule the mobile device 104 to transmit the preamble over the physical random access channel at the selected random access time and frequency slot. The preamble may be the allocated preamble or randomly selected preamble. The node 202 receives the preamble transmitted by the scheduled mobile device 104.

The node 202 then utilizes the processor 206 along with the timer 212 for measuring the timing offset at which the preamble is received from the mobile device 104. The processor 206 further determines the timing adjustment value in uplink timing of the received preamble. The timing adjustment value is the amount of time advanced or retarded from a predefined uplink transmission timing of the mobile device 104. The processor 206 transmits the determined timing adjustment value in the control message to the mobile device 104. The control message may be any existing message such as the uplink scheduling grant or downlink assignment message transmitted with low overhead over the physical random access channel. The processor 206 also indicates the presence of timing adjustment value in the control message by assigning an unused field of the control message. The processor 206 assigns the unused field by modifying the values in the unused field to indicate the presence of timing adjustment value in the control message. For example, the bits in the unused field of the control message are changed to ‘1’ to indicate that the control message has uplink timing adjustment value. Finally, the processor 206 transmits the control message comprising the timing adjustment value of uplink timing to the mobile device 104 for adjusting or controlling uplink transmission timing at the mobile device 104.

In an embodiment of FIG. 2, the system 200 is configured with a transceiver 214, which is coupled to the node 202. The transceiver 214 is known and can vary with the communication technology. The transceiver 214 operates as a receiver and a transmitter for receiving and transmitting signals via the antenna 216 from or to the network. In an embodiment, the transceiver 214 operates for receiving and transmitting signals from different mobile devices and infrastructure components (not shown) of the network. In an embodiment, the transceiver transmits the determined timing adjustment information to the mobile device for controlling uplink transmission timing at the mobile device. The transceiver 214 may be a separate transmitter and a receiver operating independently for transmitting and receiving signals in the communication network, e.g. network 100.

FIG. 3 is a block diagram of system comprising a mobile device for controlling uplink transmission timing in accordance with some embodiments of the invention. The system 300 may be suitable for use as the mobile device 104 of the communication network 100 shown in FIG. 1. The system 300 is a radio that establishes communication with the node 102. The system comprises the mobile device 302, a transceiver 310, and an antenna 312. The mobile device 302 includes a processor 304, a controller 306, and a memory 308 for controlling uplink transmission timing in the communication network 100.

The memory 308 is a common storage unit that stores the preamble allocated by the node 102. The stored preamble is a dedicated preamble that is transmitted as an uplink transmission signal to the node 102.

The processor 304 is coupled to the memory 308 for transmitting a preamble when the mobile device 302 is scheduled by the node 102. In one embodiment, the processor 304 may randomly select the preamble from a plurality of preambles in the physical random access channel. In another embodiment, the processor 304 may retrieve the stored preamble from the memory 308 and may associate the preamble with the uplink transmission signal. Further, the processor 304 receives the timing adjustment value of uplink transmission timing in the control message in response to the transmitted preamble to the node 102. The processor 304 determines whether the timing adjustment value is present in the control message. The processor 304 determines the presence of timing adjustment value based on the values in the unused field of the control message. For example, if the bits in the unused field are changed to ‘1’ then the presence of determined timing adjustment value in the control message is affirmed. The processor 304 then extracts the timing adjustment value from the control message and sends such timing adjustment value to the controller 306 in the mobile device 302.

The controller 306 is coupled to the processor 304 for controlling the uplink transmission timing of the mobile device 104. The controller 306 receives the timing adjustment value from the processor 304 and controls the uplink transmission timing. In one embodiment, the controller 306 may adjust the transmission timing corresponding to the timing adjustment value received for the previous uplink transmission. The controlled uplink transmission timing synchronizes the transmission timing between the mobile device 104 and the node 102 in the communication network 100.

Operationally, the mobile device 302 utilizes memory 308 to store the preamble allocated by the node 102. Such allocated preamble is then used as an uplink signal when the mobile device 302 is scheduled by the node 102. The mobile device 302 utilizes the processor 304 to transmit the preamble over a selected random access time and frequency slot to the node 102. In response to the transmitted preamble, the mobile device 302 receives the timing adjustment value of the uplink transmission timing in a control message. The mobile device further utilizes the controller 306 to control the uplink transmission timing based on the timing adjustment value received from the node 102.

In an embodiment of FIG. 3, the system 300 is configured with a transceiver 310, which is coupled to the mobile device 302. The transceiver 310 is known and can vary with the communication technology. The transceiver 310 operates as a receiver and a transmitter for receiving and transmitting signals via the antenna 312 from or to the network. In an embodiment, the transceiver 310 operates for receiving and transmitting signals from different mobile devices and infrastructure components (not shown) of the network. In an embodiment, the transceiver 310 may be a separate transmitter and a receiver operating independently for transmitting and receiving signals in the communication network, e.g. network 100.

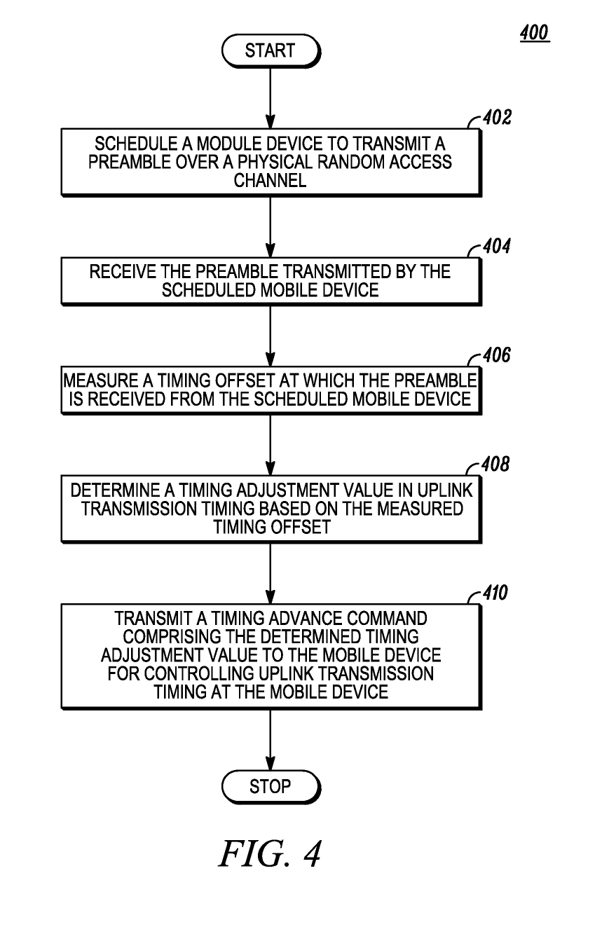

FIG. 4 is a flowchart of a method 400 for determining uplink transmission timing in accordance with some embodiments of the invention is shown. In an embodiment, the method is described from the perspective of a node, e.g. node 102 of FIG. 1. The method starts with scheduling 402 a preamble to the mobile device 104 in the communication network 100. The preamble may be a dedicated preamble or a random preamble that is associated with an uplink transmission signal at the mobile device 104.

In one embodiment, the dedicated preamble may be allocated as a signature to the mobile device 104. The signature may be used by the node 102 in recognizing the mobile device 104 from which the preamble is received. The preamble is allocated to the mobile device 104 by broadcasting the preamble to all the mobile devices 104-108 in the communication network 100. The mobile device 104 to which the preamble is allocated will associate the preamble with the uplink transmission signal and the other mobile devices will refrain from selecting such preamble.

The node 102 schedules the mobile device 104 to transmit the preamble as an uplink transmission signal. In one embodiment, the node 102 schedules the mobile device 104 to transmit the preamble periodically over a physical random access channel at a selected random access time and frequency slot. In another embodiment, the node 102 schedules the mobile device 104 to transmit the preamble in response to a request for the preamble. The request for the preamble is based on the information such as past update interval, past timing advance command, the timer expiration, the cell layout, or mobility of the mobile device, stored in the memory.

The method continues with a step of receiving 404 the allocated preamble transmitted by the scheduled mobile device 104. The node 102 receives the allocated preamble only from the scheduled mobile device 104 and thus, interference or contention in the physical random access channel is avoided. The method then continues with a step of measuring 406 a timing offset at which the preamble is received from the scheduled mobile device 104. The method then continues with a step of determining 408 a timing adjustment value in uplink transmission timing based on the measured timing offset. In one embodiment, the timing adjustment value in uplink transmission timing may be the time leading or lagging from pre-defined uplink transmission timing. The method then continues with a step of transmitting 410 a timing advance command comprising the determined timing adjustment value in a control message to the mobile device 104 for controlling uplink transmission timing at the mobile device 104. The control message is a low over head message that is transmitted over the physical random access channel. In one embodiment, the control message may be an existing uplink scheduling grant or downlink assignment message.

In one embodiment, the timing advance command comprising the uplink timing adjustment value is encapsulated in the control message. Further, the unused field of the control message is modified to indicate the presence of the timing advance command in the control message. The modified control message is then transmitted for controlling uplink transmission timing at the mobile device.

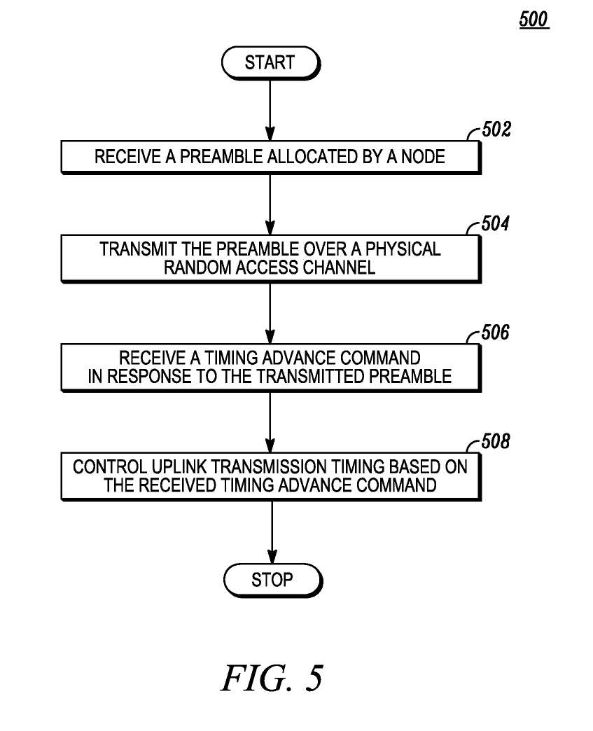

Referring to FIG. 5, a flowchart of a method 500 for controlling uplink transmission timing in accordance with some embodiments of the invention is shown. In an embodiment, the method 500 is described from the perspective of a mobile device, e.g. mobile device 104. The method 500 starts with receiving 502 a preamble allocated by the node 102 in the communication network 100. The preamble may be a dedicated preamble or a random preamble associated with the uplink signal at the mobile device 104. When the mobile device 104 is scheduled by the node, the mobile device 104 transmits the preamble as the uplink transmission signal. The method continues with a step of transmitting 504 the preamble over the physical random access channel. The preamble is a low over head uplink signal transmitted at a selected time and frequency slot. The method continues with a step of receiving 506 a timing advance command in a control message in response to the transmitted preamble. The timing advance command includes timing adjustment value of uplink transmission timing. The method then continues with the step of controlling 508 the uplink timing based on the received timing advance command. The timing adjustment value from the timing advance command in a control message is extracted, and based on the extracted timing adjustment value the uplink transmission timing is controlled.

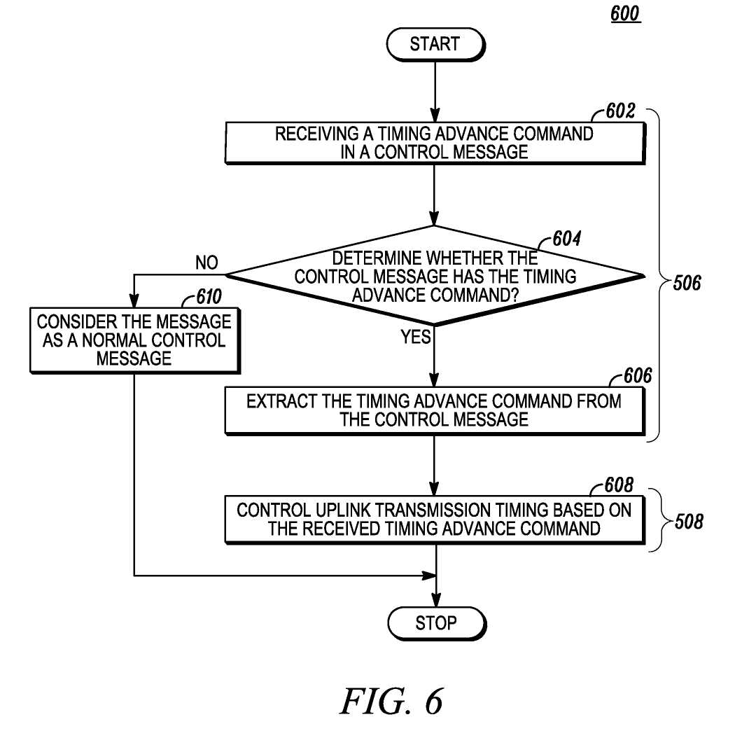

FIG. 6 is a flow chart of a method for determining the presence of timing advance command in a control message in accordance with some embodiments of the invention. The method 600 is described with reference to FIG. 1. The method 600 described from the perspective of a mobile device, e.g. mobile device 104 of FIG. 1.

The method 600 describes the steps 506 and 508 of FIG. 5 in accordance with some embodiments. The method 600 begins with the step of receiving 602 a timing advance command in a control message from the node 102. The timing advance command comprises a timing adjustment value of uplink transmission timing. In one embodiment, the timing advance command may be a data, information, or a message that may be encapsulated in the existing control message. The method continues with a step of determining 604 whether the control message has the timing advance command. The presence of timing advance command in the control message is determined based on the unused field in the control message. The unused field in the control message is modified, if the node 102 sends the timing advance command in the control message. For example, the bits in the unused field of the control message are changed to ‘1’. On the other hand, if no timing advance command is transmitted in the control message then the unused field is not modified. Thus, the change in unused field in the control message indicates that the presence of the timing advance command in the control message. Upon determining the presence of timing advance command in the control message, the method continues with a step of extracting 606 a timing adjustment value in the control message. The method then continues with a step of controlling 608 the uplink transmission timing based on the received timing adjustment value of uplink transmission timing.

On the other hand, if the control message has no timing advance command, the method moves from the step of determining 604 to the step of considering 610 the message as a normal control message and the method 600 ends.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for controlling uplink transmission timing in a communication network the method comprising:
at a node of the communication network:
scheduling a mobile device to transmit a preamble over a physical random access channel, wherein the preamble is associated with an uplink transmission signal at the mobile device;
receiving the preamble transmitted by the scheduled mobile device over the physical random access channel;
measuring a timing offset at which the preamble is received from the scheduled mobile device;
determining a timing adjustment value in uplink transmission timing based on the measured timing offset; and
transmitting a timing advance command comprising the determined timing adjustment value to the mobile device for controlling uplink transmission timing at the mobile device.

2. The method of claim 1, wherein the preamble is a dedicated preamble allocated by the node to the mobile device.

3. The method of claim 2, wherein the dedicated preamble is one of a set of preambles reserved for measuring uplink transmission timing of the mobile device.

4. The method of claim 3, wherein the set of dedicated preambles is reserved by broadcasting the set of dedicated preambles from the node to a plurality of mobile devices in the communication network to enable the mobile devices to which the preamble is not allocated to refrain from selecting the dedicated preamble.

5. The method of claim 1, wherein the preamble is randomly selected from a plurality of preambles by the scheduled mobile device.

6. The method of claim 1, wherein the timing advance command is transmitted in a control message.

7. The method of claim 6, wherein the control message is an uplink scheduling grant or downlink assignment message.

8. The method of claim 1, wherein scheduling the mobile device comprises scheduling the mobile device to transmit the preamble periodically at a selected random access time and frequency slot.

9. The method of claim 1, wherein scheduling the mobile device comprises scheduling the mobile device to transmit the preamble based on at least one of a past timing advance command, past update interval, timer expiration, a cell layout, or mobility of the mobile device.

10. The method of claim 1, wherein the node comprises a base station.

11. A method for transmitting timing advance command for controlling uplink transmission timing in a communication network, the method comprising:
at a node of the communication network:
encapsulating the timing advance command in a control message;
modifying the control message to indicate the presence of the timing advance command in the control message; and
transmitting the control message comprising the timing advance command for controlling uplink transmission timing at the mobile device.

12. The method of claim 11, wherein modifying the control message comprises assigning an unused field of the control message to indicate the presence of the timing advance command in the control message.

13. The method of claim 12, wherein assigning the unused field comprises modifying the values in the unused field to indicate the presence of the timing advance command in the control message.

14. A method for controlling uplink transmission timing in a communication network, the method comprising:
at a mobile device of the communication network:
receiving a preamble allocated by a node, wherein the preamble is associated with an uplink transmission signal;
transmitting the preamble over a physical random access channel;
receiving a timing advance command in response to the transmitted preamble, wherein the timing advance command includes a timing adjustment value in uplink transmission timing; and
controlling uplink transmission timing based on the received timing advance command.

15. The method of claim 14, wherein the preamble is a dedicated preamble allocated to the mobile device;

16. The method of claim 14, wherein the preamble is transmitted when the mobile device is scheduled by the node to transmit the preamble.

17. The method of claim 14, wherein the timing advance command is received in a control message.

18. The method of claim 17, wherein the control message is an uplink scheduling grant or downlink assignment message.

19. The method of claim 14 wherein receiving a timing advance command further comprises:
determining whether the timing advance command is present in the control message; and
extracting the timing advance command from the control message before the step of controlling the uplink transmission timing.

20. The method of claim 19, wherein the presence of timing advance command in the control message is determined based on the values in an unused field in the control message.

21. The method of claim 20, wherein the values in the unused field is modified to exhibit the presence of timing advance command in the control message.

22. The method of claim 14, wherein the mobile device comprises a radio.

23. A system for controlling uplink transmission timing in a communication network, the system comprising:
a node establishing communication with a mobile device, the node comprising:
an assigning module to allocate a preamble to the mobile device, wherein the preamble is associated with an uplink transmission signal at the mobile device;
a scheduling module to schedule the mobile device to transmit the preamble over a physical random access channel; and
a processor communicatively coupled between the assigning module and the scheduling module, the processor operable to measure a timing offset at which the preamble is received from the scheduled mobile device; and operable to determine a timing adjustment value in uplink transmission timing based on the measured timing offset; and
a transceiver for transmitting the determined timing adjustment value to the mobile device for controlling uplink transmission timing at the mobile device.

24. The system of claim 23, wherein the assigning module reserves the preamble as a dedicated preamble to the mobile device.

25. The system of claim 23 further comprising a timer coupled to the processor for monitoring the timing offset at which the preamble is received from the mobile device.

26. The system of claim 23 further comprising a memory coupled to the scheduling module for storing at least one of a past timing advance command, past update time interval, a cell layout, a timer expiration information, or mobility information of the mobile device.

27. The system of claim 23, wherein the processor is operable to modify the values in an unused field of the control message to indicate the presence of determined timing adjustment value in the control message.
